(19) United States
(12) Patent Application Publication
(10) Pub. No.: US 2015/0007716 A1
(43) Pub. Date: Jan. 8, 2015

(54) PISTON AND CARRIER ASSEMBLY

(71) Applicant: Electro-Motive Diesel, Inc., LaGrange, IL (US)

(72) Inventors: Robert T. MacVicar, Downers Grove, IL (US); Aaron G. Foege, Westmont, IL (US); Jie He, Aurora, IL (US)

(21) Appl. No.: 13/934,962

(22) Filed: Jul. 3, 2013

(51) Int. Cl. F16J 1/00

(52) U.S. Cl. CPC F16J 1/005
USPC 92/172; 29/464

(57) ABSTRACT

A piston and carrier assembly for an engine is provided. The assembly includes a thrust washer positioned at an interface of the carrier and the piston. The assembly also includes a retention means provided in cooperation with the thrust washer and a top surface of the carrier. The retention means is configured to restrict movement of the thrust washer relative to the carrier.

### TECHNICAL FIELD

The present disclosure relates to a piston and carrier assembly, and more specifically to a thrust washer for the piston and carrier assembly.

### BACKGROUND

In a reciprocating piston engine designed with a piston and carrier assembly, during operation, the piston may rotate with respect to the carrier. During the rotation of the piston with respect to the carrier, the carrier may contact the piston resulting in friction between the piston and the carrier. This friction may lead to erosion of the carrier and/or the piston. Further, frequent maintenance cycles may be required. This is laborious and may lead to a significant increase in cost associated with replacement of the carrier and/or the piston.

Generally, a thrust washer is positioned between the carrier and the piston, in order to reduce the wear between the carrier and the piston. In known systems, the thrust washer may float between the carrier and the piston during the operation of the engine. By nature of the floating of the thrust washer, the thrust washer may wear on a side of the thrust washer that contacts the carrier as well as a side of the thrust washer which contacts the piston. Since the thrust washer may be subjected to wear on both sides, it may wear more rapidly than desired.

U.S. Pat. No. 4,114,519 discloses a piston having a crown and a body connected together by bolts. The bolts pass through an annular gap defined by a pair of concentric ring members located between the crown and the body. One of the ring members is relatively resilient and the other ring member is relatively rigid. Such a construction reduces fretting between the crown and the body when the piston is in operation in an engine.

### SUMMARY OF THE DISCLOSURE

In one aspect of the present disclosure, a piston and carrier assembly for an engine is provided. The assembly includes a thrust washer positioned at an interface of the carrier and the piston. The assembly also includes a retention means provided in cooperation with the thrust washer and a top surface of the carrier. The retention means is configured to restrict movement of the thrust washer relative to the carrier.

In another aspect of the present disclosure, a method for restricting movement of a thrust washer in a piston and carrier assembly is provided. The method includes positioning the thrust washer on a top surface of the carrier. The method also includes providing a retention means in cooperation with the thrust washer and the top surface of the carrier. The method further includes affixing the thrust washer on the top surface of the carrier.

In yet another aspect of the present disclosure, a system is provided. The system includes a piston. The system includes a carrier having a top surface and a longitudinal axis, and positioned within the piston. The system includes a piston pin positioned within the carrier such that a length of the piston pin is substantially perpendicular to the longitudinal axis of the carrier. The system includes a connecting rod pivotally coupled to the piston pin. The system also includes a thrust washer positioned at an interface of the carrier and the piston. The system further includes a retention means provided in cooperation with the thrust washer and the top surface of the carrier. The retention means is configured to restrict movement of the thrust washer relative to the carrier.

Other features and aspects of this disclosure will be apparent from the following description and the accompanying drawings.

### BRIEF DESCRIPTION OF THE DRAWINGS

FIG. 1 is a perspective view of a piston and carrier assembly, according to one embodiment of the present disclosure;

FIG. 2 is a perspective view of the carrier having a thrust washer; and

FIG. 3 is a flowchart of a method for restricting movement of the thrust washer in the piston and carrier assembly.

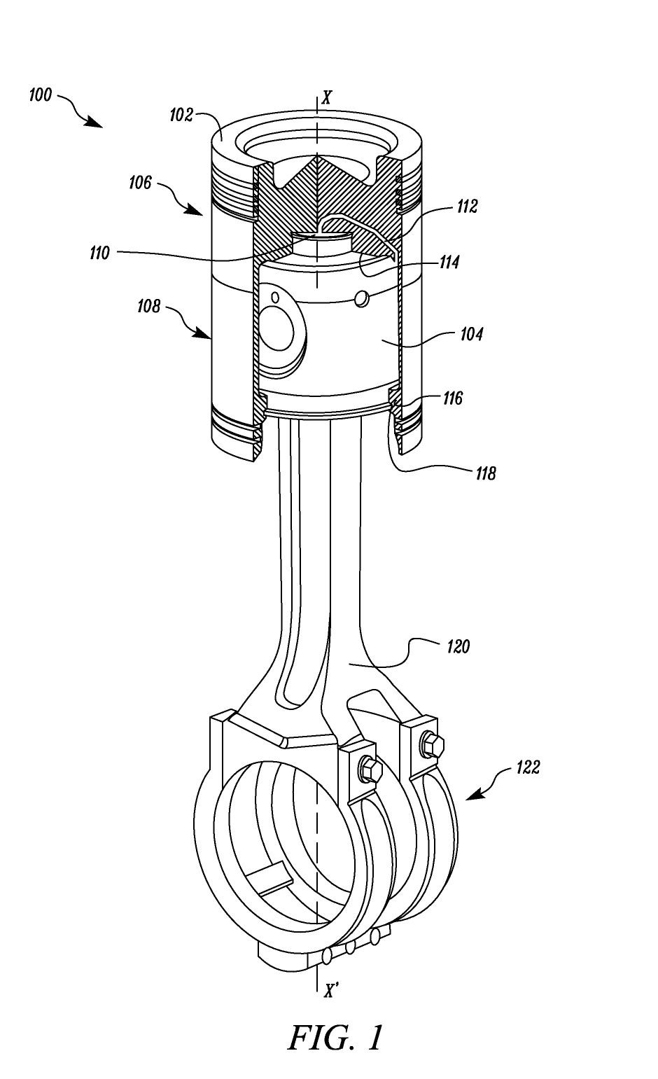

### DETAILED DESCRIPTION

Wherever possible, the same reference numbers will be used throughout the drawings to refer to the same or the like parts. Referring to FIG. 1, an assembly 100 including a piston 102 and a carrier 104 is illustrated. The assembly 100 may be provided within an engine (not shown). More specifically, the engine may be a multi cylinder internal combustion engine. The engine may be powered by any one or a combination of known liquid or gaseous fuels including, but not limited to, gasoline, diesel, natural gas, petroleum gas and biofuels. The engine may include an engine housing. The engine housing may include a cylinder head and an engine block. The engine block may include a plurality of cylinders. Each of the plurality of the cylinders may be configured to house the assembly 100. The assembly 100 may be capable of having a translatory movement relative to the cylinder.

The piston 102 may have a partially hollow cylindrical shaped configuration. The piston 102 may have a first section 106 and a second section 108. The first section 106 may be substantially solid with a partial hollow portion 110. The hollow portion 110 may have an inner diameter smaller than an outer diameter of the piston 102. The first section 106 may also be provided with at least one passage 112. The passage 112 may be configured to provide a path for lubricating and/or cooling oil to flow between the first and second sections 106, 108.

The second section 108 of the piston 102 may be substantially hollow with respect to the first section 106 such that an inner diameter of the second section 108 is substantially larger than an inner diameter of the hollow portion 110 of the first section 106. An upper restricting edge 114 may be formed in the second section 108, at an interface of the first and second sections 106, 108. A lower restricting edge 116 may be provided at a lower portion of the second section 108. The lower restricting edge 116 may be provided in a longitudinally spaced apart arrangement from the upper restricting edge 114. A circumferential groove 118 may be provided in the lower restricting edge 116.

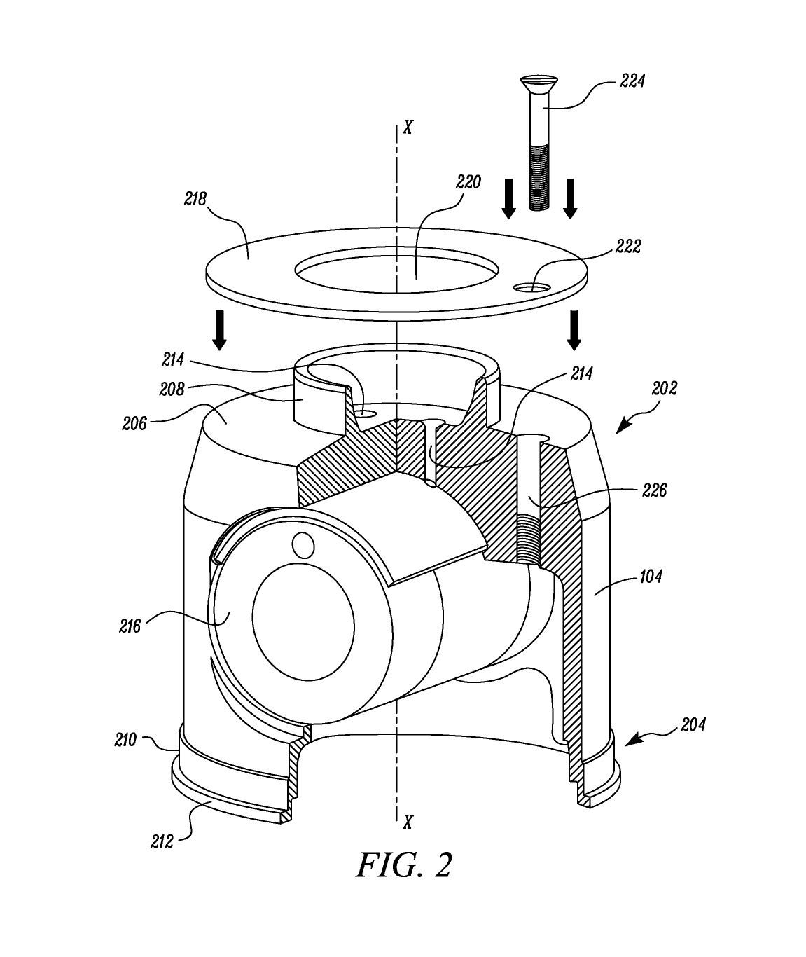

The carrier 104 may be located in the second section 108 of the piston 102, such that movement of the carrier 104 may be restricted or constrained between the upper and lower restricting edges 114, 116. Further, the piston 102 may be free to rotate about a longitudinal axis X-X with respect to the carrier 104 along the upper and lower restricting edges 114, 116. Referring to FIG. 2, the carrier 104 may have a hollow cylindrical shaped configuration having an upper region 202 and a lower region 204. The upper region 202 may have a top surface 206 having a flat configuration. During assembly, the upper restricting edge 114 of the second section 108 of the piston 102 may cooperate with the top surface 206 of the carrier 104 and may further restrict the movement of the carrier 104.

A pilot ring 208 having a hollow cylindrical configuration may be provided on the top surface 206 of the carrier 104. The pilot ring 208 may be positioned on the top surface 206 of the carrier 104 concentric to an outer diameter of the carrier 104. An outer diameter of the pilot ring 208 may be considerably smaller with respect to the outer diameter of the carrier 104. During assembly, the pilot ring 208 may be positioned within the hollow portion 110 of the first section 106 of the piston 102 provided adjacent to and in collaboration with the upper restricting edge 114 of the second section 108 of the piston 102. The pilot ring 208 may provide a guiding surface for the piston 102 to rotate relative to the carrier 104. Moreover, the pilot ring 208 may restrict a position of the carrier 104 within the piston 102 to that of a center of the piston 102.

A snap ring 210 may be provided at the lower region 204 of the carrier 104. The snap ring 210 may have a circumferential projection 212. During assembly, the circumferential projection 212 of the snap ring 210 may cooperate with the circumferential groove 118 of the lower restricting edge 116 of the second section 108 of the piston 102. The circumferential projection 212 and the circumferential groove 118 may thus form a labyrinth arrangement. Appropriate clearance may be provided to allow rotation of the circumferential projection 212 within the circumferential groove 118. The labyrinth arrangement may allow rotation of the piston 102 relative to the carrier 104. Further, the labyrinth arrangement may prevent the carrier 104 from sliding out of the piston 102.

A plurality of longitudinal channels 214 may be provided within the carrier 104 in an arrangement parallel to and spaced apart from the longitudinal axis X-X. The longitudinal channels 214 may be provided in the top surface 206 of the carrier 104 and within an area defined by the pilot ring 208. The longitudinal channels 214 may be configured to provide a path for the lubricating and/or cooling oil to flow from the top surface 206 to a piston pin 216. The piston pin 216 may be provided diametrically within the carrier 104 such that a length of the piston pin 216 may be perpendicular to the longitudinal axis X-X. The piston pin 216 may be configured to pivotally couple an eye end (not shown) of a connecting rod 120 (shown in FIG. 1) to the carrier 104. Further, a crankshaft (not shown) may be rotatably coupled to a fork end 122 of the connecting rod 120. The connecting rod 120 may be configured to convert the translatory movement of the assembly 100 to a rotary movement of the crankshaft.

As explained earlier, the piston 102 may be free to rotate with respect to the carrier 104. In doing so, the top surface 206 of the carrier 104 may contact the upper restricting edge 114 of the second section 108 of the piston 102. A thrust washer 218 may be provided at an interface of the top surface 206 and the upper restricting edge 114. The thrust washer 218 may be configured to prevent direct contact between the top surface 206 of the carrier 104 and the upper restricting edge 114 of the piston 102.

The thrust washer 218 may have a flat disc like configuration having appropriate dimensions like thickness, outer and/or inner diameter. The thrust washer 218 may be made of any one or a combination suitable polymer or metal including, but not limited to, bronze, brass and the like. It should be noted that shape, size and material of the thrust washer 218 may vary as per system design and requirements.

In the present disclosure, the thrust washer 218 may be affixed to the top surface 206 of the carrier 104 using a retention means. The retention means may restrict the movement of the thrust washer 218 relative to the top surface 206 of the carrier 104. In one embodiment, the retention means may include any known mechanical fastener like, but not limited to, bolt, screw, rivet, weld, and adhesive.

In the illustrated embodiment, the thrust washer 218 is provided with an aperture 220 concentric to an outer diameter of the thrust washer 218. The pilot ring 208 may pass through the aperture 220 of the thrust washer 218. Additionally, a hole 222 may be provided on the thrust washer 218 in order to receive a mechanical fastener 224 for affixing the thrust washer 218 on the top surface 206 of the carrier 104 by bolting. Accordingly, a bore 226 may be provided in a plane substantially perpendicular to that of the length of the piston pin 216. In other words, the bore 226 is provided parallel to and spaced apart from the longitudinal axis X-X on the top surface 206 of the carrier 104. More specifically, the bore 226 may be provided between the outer diameter of the carrier 104 and the pilot ring 208, in cooperation with the hole 222. The bore 226 may be provided in the carrier 104 so as to not interfere with the piston pin 216.

It should be noted that the bore 226 may be provided on the top surface 206 of the carrier 104 considering stress concentration that may occur in the carrier 104 due to drilling of the bore 226. For example, the bore 226 may be provided diametrically in line with the longitudinal channels 214 in order to reduce the stress concentration within the carrier 104. The bore 226 may be configured to receive the mechanical fastener 224 for affixing the thrust washer 218 on the top surface 206 of the carrier 104. Further, the mechanical fastener 224 like the bolt, screw or rivet may be provided through the hole 222 and the bore 226 to affix the thrust washer 218 on the top surface 206 of the carrier 104.

It should be noted that during the operation of the engine, stress induced in a bolted joint consisting of the mechanical fastener 224, the bore 226 and the thrust washer 218 may lead to a creep deformation of the thrust washer 218. Hence, a length of the mechanical fastener 224 may be selected to be substantially longer than mechanically necessary in order to prevent loosening of the mechanical fastener 224 due to the loss of fastener tension resulting from creep deformation of the thrust washer 218.

In another embodiment, the retention means may be the adhesive. In such an embodiment, the adhesive may be provided between the thrust washer 218 and the top surface 206 of the carrier 104. After curing of the adhesive, the thrust washer 218 may be affixed to the top surface 206 of the carrier 104 to prevent the movement of the thrust washer 218 relative to the top surface 206 of the carrier 104.

Further, in another embodiment, the retention means may be provided in the form of a groove or a recess (not shown) provided on the top surface 206 of the carrier 104. The thrust washer 218 may be configured to sit within the groove in order to prevent the movement of the thrust washer 218 relative to the top surface 206 of the carrier 104.

### INDUSTRIAL APPLICABILITY

As described earlier, the thrust washer may be positioned between the interface of the top surface of the carrier and the upper restricting edge of the piston. The thrust washer is known to serve as a sacrificial surface between the carrier and the piston. More specifically, the thrust washer may wear out when the piston rotates with respect to the carrier. Replacing the worn out thrust washer may be less expensive than replacing the carrier and/or the piston.

During operation of the engine, the piston and the carrier may be subject to extreme working conditions like high rpm of the engine, inertia, etc. Known thrust washer arrangements include positioning the thrust washer between rotating surfaces of the carrier and the piston. Hence, during the operation of the engine, the thrust washer may float in the space between the carrier and the piston. The floating of the thrust washer may result in excessive wear of the thrust washer and also leads to lowering an operable life of the thrust washer. More specifically, the wear experienced at a lower surface of the thrust washer in contact with the top surface of the carrier, may be more than an upper surface of the thrust washer. For example, in an exemplary case, during a firing process of the engine, approximately 90% wear may occur at the lower surface of the thrust washer as against approximately 10% wear at the upper surface.

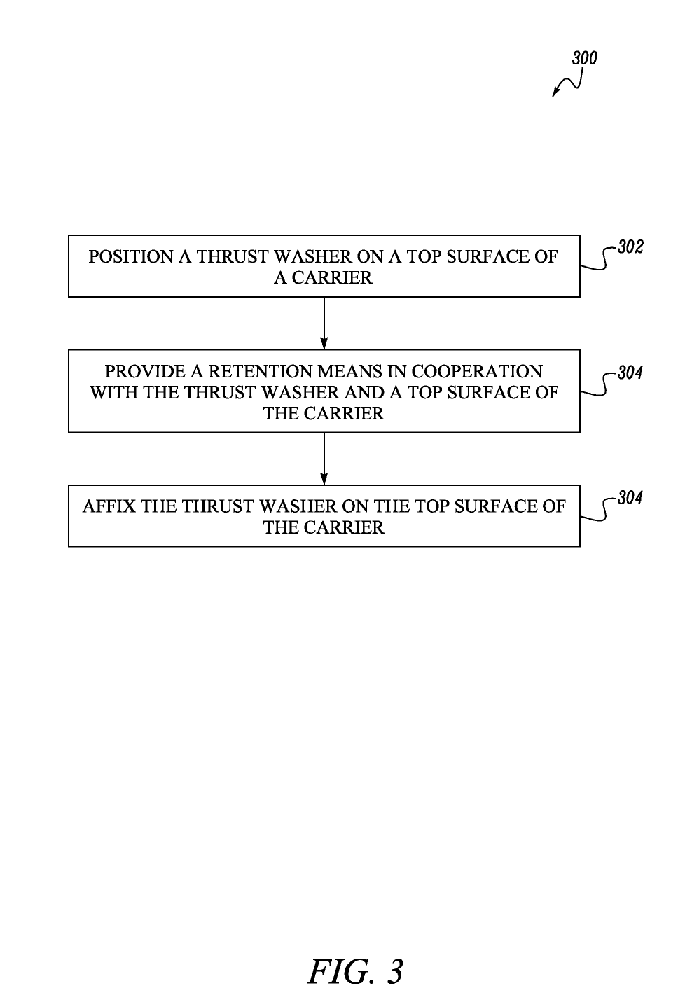

The present disclosure relates to the retention means being provided in cooperation with the thrust washer 218 and the top surface 206 of the carrier 104, in order to restrict the movement of the thrust washer 218 relative to the carrier 104. FIG. 3 is a method 300 for restricting the movement of the thrust washer 218. At step 302, the thrust washer 218 is positioned on the top surface 206 of the carrier 104. At step 304, the retention means is provided in cooperation with the thrust washer 218 at the top surface 206 of the carrier 104.

In one embodiment, the retention means may be a mechanical fastener 224 like the bolt, screw or rivet. In such an embodiment, the thrust washer 218 may be positioned on the top surface 206 of the carrier 104 in such a manner so as to appropriately align the hole 222 of the thrust washer 218 and the bore 226 of the carrier 104. The mechanical fastener 224 may then be aligned in the plane substantially perpendicular to that of the length of the piston pin 216. Further, the mechanical fastener 224 may be engaged with the thrust washer 218 and the top surface 206 of the carrier 104 by any known mechanical fastening method for example, like torqueing.

It should be noted that a torqueing force used to engage the mechanical fastener 224 with the thrust washer 218 and the top surface 206 of the carrier 104 may need to be carefully controlled. Excessive torqueing may induce detrimental stress in the mechanical fastener 224 which may lead to premature failure of the mechanical fastener 224. During the torqueing of the mechanical fastener 224, a head of the mechanical fastener 224 may be driven into the bore 226 such that a top surface of the head of the mechanical fastener 224 may be embedded below a top surface of the thrust washer 218, causing a depression to be formed on the top surface of the thrust washer 218. In doing so, the head of the mechanical fastener 224 may deform edges of the hole 222 present on the thrust washer 218. The embedding of the mechanical fastener 224 within the thrust washer 218 may prevent rubbing of the head of the mechanical fastener 224 with the piston 102.

In another embodiment, the retention means may be an adhesive. In such an embodiment, the adhesive may be provided between the thrust washer 218 and the top surface 206 of the carrier 104. Then, the thrust washer 218 may be appropriately positioned on the top surface 206 of the carrier 104 in order to hold the thrust washer 218 securely in place. External force may be applied on the thrust washer 218 in order to provide sufficient curing of the adhesive and proper adhesion of the thrust washer 218 to the top surface 206 of the carrier 104. For example, application of the external force may include using a mechanical press for a specific duration. At step 306, the thrust washer 218 may be affixed to the top surface 206 of the carrier 104 by any of the mechanical fastening methods explained above.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A piston and carrier assembly for an engine, the assembly comprising:
a thrust washer positioned at an interface of the carrier and the piston; and
a retention means provided in cooperation with the thrust washer and a top surface of the carrier, the retention means configured to restrict movement of the thrust washer relative to the carrier.

2. The assembly of claim 1, wherein the retention means comprises at least one mechanical fastener configured to affix the thrust washer on the top surface of the carrier.

3. The assembly of claim 2, wherein the at least one mechanical fastener comprises any one of a bolt and a rivet.

4. The assembly of claim 2, wherein the at least one mechanical fastener is placed in a plane substantially perpendicular to that of a length of a piston pin, the piston pin coupled to the carrier.

5. The assembly of claim 2, wherein the at least one mechanical fastener is embedded below a top surface of the thrust washer to maintain clearance to the piston.

6. The assembly of claim 1, wherein the retention means comprises an adhesive provided between the thrust washer and the top surface of the carrier, the adhesive configured to affix the thrust washer on the top surface of the carrier.

7. The assembly of claim 1, wherein the thrust washer is made of any one or a combination of a metal and a polymer.

8. A method for restricting movement of a thrust washer in a piston and carrier assembly, the method comprising:
positioning the thrust washer on a top surface of the carrier;
providing a retention means in cooperation with the thrust washer and the top surface of the carrier; and
affixing the thrust washer on the top surface of the carrier.

9. The method of claim 8, wherein providing the retention means further comprises:
aligning at least one mechanical fastener in a plane substantially perpendicular to that of a length of a piston pin, the piston pin coupled to the carrier; and
engaging the at least one mechanical fastener with the thrust washer and the top surface of the carrier.

10. The method of claim 9, wherein engaging the at least one mechanical fastener with the thrust washer further comprises embedding the at least one mechanical fastener below a top surface of the thrust washer to maintain clearance to the piston.

11. The method of claim 8, wherein providing the retention means further comprises providing an adhesive between the thrust washer and a top surface of the carrier.

12. A system comprising:
a piston;
a carrier positioned within the piston, the carrier having a top surface and a longitudinal axis;
a piston pin positioned within the carrier, a length of the piston pin being substantially perpendicular to the longitudinal axis of the carrier;
a connecting rod pivotally coupled to the piston pin;
a thrust washer positioned at an interface of the carrier and the piston; and
a retention means provided in cooperation with the thrust washer and the top surface of the carrier, the retention means configured to restrict movement of the thrust washer relative to the carrier.

13. The system of claim 12, wherein the retention means comprises at least one mechanical fastener configured to affix the thrust washer on the top surface of the carrier.

14. The system of claim 13, wherein the at least one mechanical fastener comprises any one of a bolt and a rivet.

15. The system of claim 13, wherein the at least one mechanical fastener is placed in a plane substantially perpendicular to that of a length of the piston pin.

16. The system of claim 13, wherein the at least one mechanical fastener is embedded below a top surface of the thrust washer to maintain clearance to the piston.

17. The system of claim 12, wherein the retention means comprises an adhesive provided between the thrust washer and the top surface of the carrier, the adhesive configured to affix the thrust washer on the top surface of the carrier.

18. The system of claim 12, wherein the thrust washer is made of any one or a combination of a metal and a polymer.
